(19) United States
(12) Patent Application Publication
(10) Pub. No.: US 2005/0244752 A1
(43) Pub. Date: Nov. 3, 2005

(54) Radiation-curable resin composition for adhesives

(76) Inventors: Junji Yoshizawa, Toyko (JP); Atsuya Takahashi, Tokyo (JP); Masahito Mase, Tokyo (JP); Zen Komiya, Tokyo (JP)

Correspondence Address: MAYER, BROWN, ROWE & MAW LLP, 1909 K STREET, N.W., WASHINGTON, DC, 20006, US

(21) Appl. No.: 10/508,993

(22) PCT Filed: Mar. 23, 2003
(86) PCT No.: PCT/NL03/00232

§ 371 Date: Jul. 11, 2005

(30) Foreign Application Priority Data
Mar. 27, 2002 (JP) 2002-089367

(51) Int. Cl. G11B 7/24

(52) U.S. Cl. 430/270.12

(57) ABSTRACT

A radiation-curable resin composition for adhesives comprising (A) a bisphenol-type epoxy (meth)acrylate having a hydroxyl group, (B) a polyfunctional (meth)acrylate having an aliphatic cyclic structure or an aromatic cyclic structure other than the component (A), and (C) a photoinitiator, wherein the content of the component (A) and the content of the component (B) in the composition are respectively 30 wt % or more. The radiation-curable resin composition for adhesives of the present invention exhibits excellent adhesion to silver, silicon compound, and aluminum, superior moisture-heat resistance, and fast curability, especially at the edge of the disk, and therefore is very useful in the manufacture of optical disks in comparison with conventional adhesives.

The invention relates to a radiation-curable resin composition for adhesives comprising (A) a bisphenol-type epoxy (meth)acrylate having a hydroxyl group, (B) a polyfunctional (meth)acrylate having an aliphatic cyclic structure or an aromatic cyclic structure other than the component (A), and (C) a photoinitiator. The invention also relates to an adhesive for optical disks comprising the composition, and to optical disks comprising the composition and/or the adhesive.

Recent progress in information technology represented by computer hardware technology, computer software technology, and communication technology has enabled much more information to be transmitted at high speed. Accompanied by this, recording media capable of recording more information at high density have been demanded, and development of such recording media has progressed. As such high-density recording media, a DVD (digital video disc or digital versatile disk) has been developed as a general-purpose recording medium for the next generation. The DVD is manufactured by attaching two disks together. Therefore, an adhesive for causing two disks to adhere is necessary. Use of a hot-melt adhesive, heat-curable adhesive, anaerobic curable adhesive, and the like has been attempted. However, the hot-melt adhesive has insufficient heat stability and weatherability and therefore softens at high temperature, thereby causing the disks to be separated or deformed due to a decrease in adhesion. Moreover, it is difficult to apply a hot-melt adhesive to the two-layered DVD having a translucent film as a recording film due to insufficient transparency. A problem with the heat-curable adhesive is its exothermic properties that cause substrates forming the disks to be deformed due to heat during curing. Moreover, a long period of time is required for curing the adhesive. The anaerobic curable adhesive exhibits inferior productivity because a long period of time is required for curing the adhesive. In order to solve these problems, photocurable adhesives have been proposed. For example, Japanese Patent Applications Laid-open No. 61-142545 and No. 6-89462 disclose UV-curable resin adhesives containing a urethane acrylate as a main component.

Silver, an alloy containing silver as a main component, silicon and an alloy containing silicon as the main component are inexpensive in comparison with gold and are used as a material for a translucent film for DVD-9. However, in the case of replacing gold with silver, an alloy containing silver as a main component, silicon, or a compound containing silicon as a main component, sufficient adhesion may not be obtained due to changes in adhesion with the adhesive. Moreover, silver, an alloy containing silver as a main component, silicon, or a compound containing silicon as a main component are chemically unstable in comparison with gold. As a result, in the case of using a conventional adhesive for DVDs, silver, an alloy containing silver as a main component, silicon, or a compound containing silicon as a main component is changed into a black substance or a white substance when allowed to stand at a high temperature and a high humidity for a long period of time, whereby data on the DVD may not be readable due to a decrease in reflectance.

In addition, curability at the edge of the disk is also required.

A conventional UV-curable resin adhesive is not fully satisfactory with respect to moisture-heat resistance, curability at the edge of the disk as well as adhesion to a translucent film made of silver, an alloy containing silver as a main component, silicon or a compound containing silicon as a main component or adhesion to a reflection film made of aluminum, at the same time.

Accordingly, an object of the present invention is to provide a radiation-curable resin composition for adhesives excelling in adhesion to silver, a compound or an alloy containing silver as a main component, silicon, or a compound or alloy containing silicon as a main component, and aluminum or a compound or alloy containing aluminum as a main component and having superior moisture-heat resistance and curability at the edge of the disk in comparison with a conventional composition, and also to provide an adhesive for optical disks comprising the composition.

It has been found that the above object can be achieved by a specific radiation-curable resin composition for adhesives given below.

Specifically, the present invention provides a radiation-curable resin composition for adhesives comprising (A) a bisphenol-type epoxy acrylate having a hydroxyl group, (B) a polyfunctional (meth)acrylate having an aliphatic cyclic structure or an aromatic cyclic structure other than the component (A), and (C) a photoinitiator, wherein the content of the component (A) and the content of the component (B) in the composition are respectively 30 wt % or more.

As examples of the bisphenol-type epoxy (meth)acrylate having a hydroxyl group of the component (A) used in the radiation-curable resin composition for adhesives of the present invention, a bisphenol A-type epoxy (meth)acrylate having a hydroxyl group and a bisphenol F-type epoxy (meth)acrylate having a hydroxyl group can be given, with those possessing a bisphenol A structure (i.e., bisphenol A-type epoxy (meth)acrylate) being preferable. As examples of the bisphenol-type epoxy (meth)acrylate, an adduct of bisphenol A diglycidyl ether (meth)acrylate and the like can be given.

The component (A) preferably contains 1.5-3 (meth)acryloyl groups in one molecule. The number average molecular weight of the component (A) is preferably from 400 to 3,000.

As commercially available epoxy acrylates, Epoxy Ester 3002M, 3002A, 3000M, 3000A (manufactured by Kyoeisha Chemical Co., Ltd.), EA-1370 (manufactured by Mitsubishi Chemical Corporation), Viscoat #540 (manufactured by Osaka Organic Chemical Industry Ltd.), SP-1506, SP-1507, SP-1509, SP-1519-1, SP-1563, SP-2500, VR60, VR77, VR90 (manufactured by Showa Highpolymer Co., Ltd.), and the like can be given.

The proportion of the component (A) used in the radiation-curable resin composition for adhesives of the present invention is usually 30 wt % or more, preferably 35 wt % or more, and more preferably 40 wt % or more of the total amount of the composition. If the proportion of the component (A) is less than 30 wt %, it is difficult to maintain sufficient adhesion to metal layers of silver, a compound or an alloy containing silver as a main component, silicon, or a compound or alloy containing silicon as a main component, or aluminum or a compound or alloy containing aluminum as a main component, and the like. When silver, silicon or aluminum are used in a compound or alloy, the preferably are present as the main component, i.e as the component having the highest weight percentage in the total composition forming the translucent or reflective layer.

In this text, the term polyfunctional (meth)acrylate is defined as a (meth)acrylate having more than one (meth)acrylate groups.

As polyfunctional (meth)acrylates possessing an aliphatic cyclic structure or aromatic cyclic structure other than the component (A) that can be used in the present invention as the component (B), polyfunctional (meth)acrylates possessing an aliphatic cyclic structure having 6-12 carbon atoms or an aromatic cyclic structure having 6-12 carbon atoms can be given. As the polyfunctional (meth)acrylates possessing an aliphatic cyclic structure, C₂-C₄ alkylene oxide adducts of hydrogenated bisphenol A di(meth)acrylate and C₂-C₄ alkylene oxide adducts of bisphenol F di(meth)acrylate such as tricyclodecanemethanol di(meth)acrylate, cyclohexanedimethanol di(meth)acrylate, ethylene oxide adduct of hydrogenated bisphenol A di(meth)acrylate, ethylene oxide adduct of hydrogenated bisphenol F di(meth)acrylate, propylene oxide adduct of hydrogenated bisphenol A di(meth)acrylate, propylene oxide adduct of hydrogenated bisphenol F di(meth)acrylate, and the like can be given. As the polyfunctional (meth)acrylates possessing an aromatic cyclic structure, C₂-C₄ alkylene oxide adducts of bisphenol A di(meth)acrylate and C₂-C₄ alkylene oxide adducts of bisphenol F di(meth)acrylate such as ethylene oxide adduct of bisphenol A di(meth)acrylate, ethylene oxide adduct of bisphenol F di(meth)acrylate, propylene oxide adduct of bisphenol A di(meth)acrylate, propylene oxide adduct of bisphenol F di(meth)acrylate, and the like can be given.

To increase the rigidity and strength of the adhesive, a polyfunctional (meth)acrylate possessing an aliphatic cyclic structure is preferably used as the polyfunctional (meth)acrylate component (B). The use of tricyclodecanedimethanol di(meth)acrylate as the component (B) is even more preferable. It is also possible to use as component (B) a mixture of polyfunctional (meth)acrylates possessing an aliphatic cyclic structure or aromatic cyclic structure other than the component (A). However, preferably component (B) is not a mixture. If the crosslinking density of the adhesive is too high, the cure shrinkage rate increases and warping of the disk occurs. To prevent this problem, the component (B) preferably contains on average 1.5-3 (meth)acryloyl groups in one molecule. Most preferably, component (B) contains 2-3 (meth)acryloyl groups in the molecule.

As examples of commercially available products suitably used as the component (B), SA-1002, SA-2006, DX-TEMA (manufactured by Mitsubishi Chemical Corporation), Viscoat #3700, Viscoat #700 (manufactured by Osaka Organic Chemical Industry Co., Ltd.), KAYARAD R-551, R-71 2, R-604, R-684, HBA-024E, HBA-024P (manufactured by Nippon Kayaku Co., Ltd.), ARONIX M-203, M-208, M-210 (manufactured by Toagosei Co., Ltd.), CD401, CD406, CD540, CD541, CD542, SR348, SR349, SR480, CD581, CD582, SR601, SR602, CD9038, SR9036 (manufactured by Sartomer Company), GX-8345, GX-8465, GX-8448D, GX-8449 (manufactured by Daiichi Kogyo Seiyaku Co., Ltd.), LIGHT-ESTER BP-2EM, BP-4EM, BP-4PA, LIGHT-ACRYLATE DCP-A, LIGHT-ACRYLATE BP-134 (manufactured by Kyoeisha Chemical Co., Ltd.), and the like can be given.

The proportion of the component (B) used in the radiation-curable resin composition for adhesives of the present invention is usually 30 wt % or more, preferably 35 wt % or more, and more preferably 40 wt % or more of the total amount of the composition. If the amount of the component (B) used is less than 30 wt %, the rigidity and strength of the adhesive decreases.

The following compounds can be given as examples of photoinitiators: 2,2-dimethoxy-1,2-diphenylethan-1-one, 2-hydroxy-2-methyl-1-phenylpropan-1-one, 1-hydroxy-cyclohexyl phenyl ketone, 2,4,6-trimethylbenzoyldiphenylphosphine oxide, bis(2,4,6-trimethylbenzoyl)phenylphosphine oxide, 3-methylacetophenone, 2,2-dimethoxy-2-phenylacetophenone, xanthone, fluorenone, benzaldehyde, fluorene, anthraquinone, triphenylamine, carbazole, 3-methylacetophenone, benzophenone, 4-chlorobenzophenone, 4,4′-dimethoxybenzophenone, 4,4′-diaminobenzophenone, benzoin ethyl ether, benzoin propyl ether, Michler's ketone, benzyl dimethyl ketal, 1-(4-isopropylphenyl)-2-hydroxy-2-methylpropan-1-one, 1-(4-dodecylphenyl)-2-hydroxy-2-methylpropan-1-one, 4-(2-hydroxyethoxy)phenyl-(2-hydroxy-2-propyl) ketone, 2-methyl-1-[4-(methylthio)phenyl]-2-morpholino-propan-1-one, 2,4,6-trimethylbenzoylphenyl phosphinate, 2,4,6-trimethylbenzoyidiphenylphosphine oxide, 2-benzyl-2-dimethylamino-1-(4-morpholinophenyl)-butan-1-one, bis(2,6-dimethoxybenzoyl)-2,4,4-trimethylpentylphosphine oxide, methylbenzoyl formate, thioxanethone, diethylthioxanthone, 2-isopropylthioxanthone, 2-chlorothioxanthone, and oligo[2-hydroxy-2-methyl-1-[4-(1-methylvinyl)phenyl]propanone]. Of these, 2,2-dimethoxy-1,2-diphenylethan-1-one, 2-hydroxy-2-methyl-1-phenylpropan-1-one, 1-hydroxycyclohexyl phenyl ketone, 2,4,6-trimethylbenzoyidiphenylphosphine oxide, and bis(2,4,6-trimethylbenzoyl)phenylphosphine oxide are preferred. In order to improve curability of the edge surface, use of two types of photoinitiators selected from these compounds in combination is preferable.

As examples of commercially available products of these compounds, IRGACURE 184, 261, 369, 500, 651, 819, 907, 1700, 1800, 1850,2959, Darocur 953, 1116, 1173, 1664, 2273, 4265 (manufactured by Ciba Specialty Chemicals Co., Ltd.), Lucirin TPO, LR8728, LR8893 (manufactured by BASF), Ubecryl P36 (manufactured by UCB), VICURE55 (manufactured by Akzo), ESACURE KIP100F, KIP150 (manufactured by Lamberti), KAYACURE CTX, DETX, BP-100, BMS, 2-EAQ (manufactured by Nippon Kayaku Co., Ltd.), and the like can be given. Of these, Irgacure 184, 500, 651, 819, Darocur 1173, 4265, Lucirin TPO, LR8728, and LR8893 are preferable.

In order to maintain corrosion resistance and surface edge curability and to ensure rigidity of the adhesive, the amount of the component (C) used in the radiation-curable resin composition for adhesives of the present invention is 0.01-15 wt %, preferably 0.05-10 wt %, and still more preferably 0.1-10 wt %. When only 2,4,6-trimethylbenzoyldiphenylphosphine oxide or bis(2,4,6-trimethylbenzoyl)phenylphosphine oxide is used as the component (C), the amount is preferably 0.1-1.5 wt % from the viewpoint of moisture-heat resistance.

The radiation-curable resin composition for adhesives of the present invention may further comprise (D) a dialkylamino benzoate. By the addition of the component (D), tackiness on the surface edge can be reduced, and the curability of the surface edge can be improved when the disk is set and cured. As the component (D) used in the present invention, alkyl esters (methyl ester, ethyl ester, propyl ester, butyl ester, isoamyl ester, etc.) of dialkylaminobenzoic acid (alkyl dialkylaminobenzoate) can be given. As alkyl groups in the dialkylamino group, alkyl groups having 1-6 carbon atoms are preferable. As the ester residue, alkyl groups having 1-6 carbon atoms are preferable. The dialkylamino group and carboxyl group of dialkylaminobenzoate preferably bond to the benzene ring at a p-position. Of these, ethyl p-dimethylaminobenzoate is particularly preferable.

As examples of commercially available products used as the component (D), KAYACURE EPA, KAYACURE DMBI (manufactured by Nippon Kayaku Co., Ltd.), and the like can be given.

The proportion of the dialkylaminobenzoic acid used as the component (D) of the present invention is preferably 0.05-5 wt %, more preferably 0.1-3 wt %, and particularly preferably 0.2-1 wt % in view of edge curability and moisture-heat resistance.

The radiation-curable resin composition for adhesives of the present invention may further comprise (E) an aromatic thiol compound. The addition of the component (E) improves moisture-heat resistance when using silver, an alloy containing silver as a main component, silicon compound, or an alloy containing silicon as a main component. As the aromatic thiol compound, an aromatic heterocyclic compound containing a mercapto group is preferable. As specific examples of such a compound, mercaptobenzoxazole, mercaptobenzothiazole, 1-phenyl-5-mercapto-1H-tetrazole, and the like can be given. As commercially available products of the component (E), Nocceler M, Nocceler M-P, Nocrac MB, Nocrac MMB (manufactured by Ouchishinko Chemical Industrial Co., Ltd.), Accel M, Antage MB (manufactured by Kawaguchi Chemical Industry Co., Ltd.), Sanceler M, Sanceler M-G (manufactured by Sanshin Chemical Industry Co., Ltd.), Soxinol M, Sumilizer MB (manufactured by Sumitomo Chemical Co., Ltd.), and the like can be given.

In view of moisture-heat resistance with silver and silicon, the content of the component (E) in the composition is preferably 0.01-5 wt %, and still more preferably 0.05-4 wt %.

A (meth)acrylate compound containing at least one (meth)acryloyl group in the molecule other than the components (A) and (B) may be added to the composition of the present invention. Any of monofunctional compounds containing one (meth)acryloyl group and polyfunctional compounds containing two or more (meth)acryloyl groups may be used. These compounds may be used in combination at an appropriate proportion. As the (meth)acrylate compound containing at least one (meth)acryloyl group in the molecule other than the components (A) and (B), tetrafurfuryl acrylate, 4-hydroxybutyl acrylate, tetraethylene glycol diacrylate, tripropylene glycol diacrylate, neopentyl glycol diacrylate, and the like can be given.

The composition of the present invention may additionally contain a urethane (meth)acrylate. A urethane (meth)acrylate can be prepared by reacting a polyol compound, a polyisocyanate compound, and a hydroxyl group-containing (meth)acrylate compound.

As the polyol compound, polyether polyols, polyester polyols, polycarbonate polyols, polycaprolactone polyols, aliphatic hydrocarbons having two or more hydroxyl groups in the molecule, alicyclic hydrocarbons having two or more hydroxyl groups in the molecule, unsaturated hydrocarbons having two or more hydroxyl groups in the molecule, and the like can be used. These polyols may be used either individually or in combination of two or more.

As examples of polyether polyols, aliphatic polyether polyols, alicyclic polyether polyols, and aromatic polyether polyols can be given.

As a method for synthesizing the urethane (meth)acrylates, the following methods (i) to (iii) can be given. However, the method is not limited to these.
(i) A method of reacting a polyisocyanate (b) and a hydroxyl group-containing (meth)acrylate (c), and reacting the resulting product with a polyol (a).
(ii) A method of reacting the polyol (a), polyisocyanate (b), and hydroxyl group-containing (meth)acrylate (c) at the same time.
(iii) A method of reacting the polyol (a) and polyisocyanate (b), then reacting the resulting compound with the hydroxyl group-containing (meth)acrylate (c).

It is preferable to synthesize the urethane (meth)acrylate used in the present invention using a urethanization catalyst such as copper naphthenate, cobalt naphthenate, zinc naphthenate, di-n-butyltin dilaurate, triethylamine, 1,4-diazabicyclo[2.2.2]octane, or 1,4-diaza-2-methylbicyclo[2.2.2]octane in an amount of 0.01-1 part by weight for 100 parts by weight of the reaction product. The reaction temperature is usually from 0 to 90° C., and preferably from 10 to 80° C.

Silane coupling agents other than the component (E) may be added to the composition of the present invention in addition to the components (A) to (E).

The composition of the present invention may additionally contain radically polymerizable compounds other than the compounds containing an acryloyl group. N-vinylcaprolactam and the like can be giving as examples of this compound.

Moreover, epoxy resins, polyamides, polyamideimides, polyurethanes, polybutadienes, chloroprenes, polyethers, polyesters, pentadiene derivatives, SBS (styrene/butadiene/styrene block copolymer), hydrogenated SBS, SIS (styrene/isoprene/styrene block copolymer), petroleum resins, xylene resins, ketone resins, fluorine-containing oligomers, silicone oligomers, polysulfide oligomers, and the like may be added to the composition of the present invention as other additives.

In addition to the above additives, paint additives such as antioxidants, UV absorbers, light stabilizers, aging preventives, anti-foaming agents, leveling agents, antistatic agents, surfactants, preservatives, heat-polymerization inhibitors, plasticizers, and wettability improvers may be added to the composition of the present invention. As examples of the antioxidants, Irganox 1035 (manufactured by Ciba Specialty Chemicals Co., Ltd.) and the like can be given.

The viscosity of the composition of the present invention is preferably 10-10,000 mPa.s, still more preferably 50-5,000 mPa.s, and particularly preferably 150-2,000 mPa.s.

It is preferable to add each component so that the glass transition temperature of the resulting cured product is −30 to 250° C., preferably 0 to 200° C., and even more preferably 50 to 180° C. If the glass transition temperature is too low, the cured product softens in summer or in a closed sunny room at high temperature, whereby a substrate may be dislodged or may move due to decreased adhesion. If the glass transition temperature is too high, adhesion may be insufficient or the substrate may break when dropped or bent.

The term “glass transition temperature” used herein means a temperature indicating a maximum value of the loss tangent (tan δ) measured using a dynamic viscoelasticity measurement device at an oscillation frequency of 10 Hz.

The composition of the present invention is cured by irradiating the composition with ultraviolet rays, visible rays, electron beams, or the like in the same manner as in conventional photocurable resin compositions. The objects to be adhered can be easily adhered by placing the composition of the present invention between them to produce an adhesive layer with a preferable thickness of 10-100 μm and curing the composition by irradiation using for example a metal halide lamp at a dose preferably in the range of 50-2000 mJ/cm².

The photocured product of the composition of the present invention preferably has excellent transparency. For example, the cured product with a thickness of 60 μm preferably has a light transmittance of 90% or more at 600-700 nm. If the light transmittance is less than 90%, the appearance of an optical disk may be impaired. Moreover, light to read the information stored in the disk is reduced by the adhesive layer of the cured product, thereby hindering read operations. Therefore, it is preferable to prepare the composition of the present invention by combining each component so that the light transmittance of the cured product is in the above range.

It is preferable to add each component so that the photocured product of the composition of the present invention has a refractive index of 1.51-1.70 at 25° C. If the refractive index of the photocured product is out of this range, problems may occur when reading the information stored in the disk.

The composition of the present invention exhibits good adhesion to plastics such as polycarbonate (PC) and polymethylmethacrylate (PMMA), metals such as gold, aluminum, and silver and alloys comprising at least one of these metals, and to silicon, and compounds comprising silicon as the main component, inorganic compounds such as glass, and the like. Therefore, the composition is suitable as an adhesive for optical disks.

### EXAMPLES

The present invention will be described by examples, which should not be construed as limiting the present invention.

Synthesis of Urethane Acrylate:

### Synthesis Example 1

A 1-liter separable flask equipped with a stirrer and a thermometer was charged with 209 g of isophorone diisocyanate, 0.2 g of 3,5-di-t-butyl-4-hydroxytoluene, and 0.8 g of di-n-butyltin dilaurate. The mixture was stirred and cooled to 10° C. in a water bath in dry air. 109 g of 2-hydroxyethyl acrylate was added slowly at 10-35° C. over one hour and allowed to react. After the addition of 305.5 g of polytetramethylene glycol with an average molecular weight of 650 (“PTMG 650” manufactured by Mitsubishi Chemical Corp.), the mixture was allowed to react at 40-60° C. for 5 hours while stirring. The reaction product was removed to obtain urethane acrylate (UA) with a number average molecular weight of 1,300. This component is described in Tables 1 and 2 as Oligomer (UA)

### Examples and Comparative Examples

Preparation of Radiation-Curable Resin Composition for Adhesives

A reaction vessel equipped with a stirrer was charged with components of the compositions shown in Tables 1 and 2. The mixture was stirred for 1 hour at 50° C. to prepare the coating film compositions of Examples 1-13 and Comparative Examples 1-3. The components shown in Tables 1 and 2 are as follows. The amount of the components in Table 1 is indicated by parts by weight.

Component (A)

Bisphenol A diglycidyl ether acrylate adduct (“VR-77” manufactured by Showa Highpolymer Co., Ltd.)

Component (B)

Tricyclodecanedimethylol diacrylate (“Upimer SA-1 002” manufactured by Mitsubishi Chemical Corp.)

Bisphenol A-type ethylene oxide addition diacrylate (“Viscoat #700” manufactured by Osaka Organic Chemical Industry Co., Ltd.)

Component (C)

2,2-Dimethoxy-1,2-diphenylethan-1-one (“Irgacure 651” manufactured by Ciba Specialty Chemicals Co., Ltd.)

2-hydroxy-2-methyl-1-phenyl-propan-1-one (“Darocur 1173” manufactured by Ciba Specialty Chemicals Co., Ltd.)

1-Hydroxycyclohexyl phenyl ketone (“Irgacure 184” manufactured by Ciba Specialty Chemicals Co., Ltd.)

2,4,6-Trimethylbenzoyidiphenylphosphine oxide (“Lucirin TPO-X” manufactured by BASF)

Bis(2,4,6-trimethylbenzoyl)-phenylphosphineoxide (“Irgacure 819” manufactured by Ciba Specialty Chemicals Co., Ltd.)

Component (D)

Ethyl dimethylaminobenzoate (“KAYACURE EPA” manufactured by Nippon Kayaku Co., Ltd.)

Component (E)

2-Mercaptobenzothiazole (manufactured by Tokyo Kasei Kogyo Co., Ltd.)

Other Components

Tetrafurfurylacrylate (“Viscoat 150” manufactured by Osaka Organic Chemical Industry Co., Ltd.)

Tetraethylene glycol diacrylate (“Light Acrylate 4EGA” manufactured by Kyoeisha Chemical Co., Ltd.)

Tripropylene glycol diacrylate (“NK ESTER APG-200” manufactured by Shin-Nakamura Chemical Co., Ltd.)

N-Vinylcaprolactam (manufactured by BASF)

2,2-thio-diethylene bis[3-(3,5-di-t-butyl-4-hydroxyphenyl) propionate] (“Irganox 1035” manufactured by Ciba Specialty Chemicals Co., Ltd.)

The compositions thus prepared (compositions of Examples 1-13 and Comparative Examples 1-3) were applied to a substrate to form a cured film and the adhesion to substrates, moisture-heat resistance, and edge curability were measured and evaluated as described below.

(1) Adhesion to Substrates (Adhesiveness)

The composition was applied onto a silver film, silicon film, or aluminum film deposited on a PC substrate using a sputtering method. The composition was irradiated at a dose of 100 mJ/cm² in a nitrogen atmosphere to obtain a cured film of the composition with a thickness of 50 μm. The cured film was then subjected to a cross cut cellophane tape peeling test. A Crosscut Cellotape (trademark) peeling test was repeated 10 times. Adhesiveness was judged as satisfactory when the adhesive did not peel off the silver film, silicon film, or aluminum film, respectively. Those receiving satisfactory results 10 times were judged as “Excellent”, those receiving satisfactory results 8-9 times were judged as “Very good”, and those receiving satisfactory results 6-7 times were judged as “Good”. If peeling was observed or more times, adhesiveness was judged as “Bad”.

(2) Moisture-Heat Resistance

Three pairs of PC substrates with a different coated film deposited thereon by sputtering; (1) a translucent silver film and a silver film, (2) a translucent silver film and an aluminum film, and (3) a translucent silicon film and an aluminum film, were provided. A coated film with a thickness of 50 μm was produced by spin coating between each pair of PC substrates and irradiated at a dose of 500 mJ/cm² in the air to cause them to adhere. In the case where abnormalities such as foam or corrosion were observed in the adhesive layer or the interface between the adhesive and the substrates after allowing to stand in a thermo-hygrostat at a temperature of 80° C. and a relative humidity of 95% for 192 hours, moisture-heat resistance of the composition was judged as “Bad”. In the case where no abnormalities were observed, moisture-heat resistance of the composition was judged as “Good”. Those not displaying abnormalities after being allowed to stand in a thermo-hygrostat at a temperature of 80° C. and a relative humidity of 95% for 192 hours were judged as “Very good”, and those not displaying abnormalities after 384 hours were judged as “Excellent”.

(3) Edge Curability

Three pairs of PC substrates with a different coated film deposited thereon by sputtering; (1) a translucent silver film and a silver film, (2) a translucent silver film and an aluminum film, and (3) a translucent silicon film and an aluminum film, were provided. A coated film with a thickness of 50 μm was produced by spin coating between each pair of PC substrates and irradiated at a dose of 500 mJ/cm² in the air to cause them to adhere. In the case where tackiness (viscosity) was noted when the edge of the disk thus obtained was touched, edge curability of the composition was judged as “Bad”. In the case where there was no tackiness, edge curability of the composition was judged as “Good”. Furthermore, those not displaying tackiness when irradiated at a dose of 200 mJ/cm² were judged as “Very good”, and those not displaying tackiness when irradiated at a dose of 100 mJ/cm² were judged as “Excellent”.

The results of the above evaluations are shown in Tables 1 and 2. As is clear from these results, the compositions in Examples 1-13 containing the essential components (A) to (C) exhibited excellent curability, excellent moisture-heat resistance, and good adhesion to the sputtered metal surface. The composition in Comparative Example 1 which contained a low content of the component (A) exhibited poor curability. The compositions in Comparative Examples 2 and 3 which contained a low content of the component (B) exhibited inferior moisture-heat resistance and inferior edge-curability.

TABLE 1

| | | Example 1 | Example 2 | Example 3 | Example 4 | Example 5 | Example 6 | Example 7 | Example 8 |
|---|---|---|---|---|---|---|---|---|---|
| A | VR77 (bisphenol A diglycidyl ether acrylate | 40 | 35 | 30 | 30 | 35 | 35 | 35 | 35 |
| | adduct) | | | | | | | | |
| B | Tricyclodecanedimethanol diacrylate | 40 | 40 | 30 | 30 | 58.2 | 58.2 | 58.7 | |
| | Ethylene oxide addition bisphenol A diacrylate | | | | | | | | 30 |
| | Tetrafurfuryl Acrylate | | | | | | | | 5 |
| | Tetraethylene glycol diacrylate | 7.7 | 7.7 | 11.7 | 14.7 | | | | 17.7 |
| | Tripropylene glycol diacrylate | | 5 | 16 | 13 | | | | |
| | N-Vinyl caprolactam | 5 | 5 | 5 | 5 | | | | 5 |
| | Oligomer (UA) | | | | | | | | |
| C | 2,2-Dimethoxy-1,2-diphenylethan-1-one | 3 | 3 | 3 | 3 | 3 | 3 | 3 | 3 |
| | 2-Hydroxy-2-methyl-1-phenylpropan-1-one | 3 | 3 | 3 | 3 | 3 | 3 | 3 | 3 |
| | 1-Hydroxycyclohexyl phenyl ketone | | | | | | | | |
| | 2,4,6-Trimethylbenzoyldiphenylphosphine | | | | | | | | |
| | oxide | | | | | | | | |
| | Bis(2,4,6-trimethylbenzoyl)phenylphosphine | | | | | | | | |
| | oxide | | | | | | | | |
| D | Ethyl dimethylaminobenzoate | 0.5 | 0.5 | 0.5 | 0.5 | 0.5 | | | 0.5 |
| E | 2-Mercaptobenzothiazole | 0.5 | 0.5 | 0.5 | 0.5 | | 0.5 | | 0.5 |
| | Irganox 1035 | 0.3 | 0.3 | 0.3 | 0.3 | 0.3 | 0.3 | 0.3 | 0.3 |

Adhesiveness

| | | | | | | | | |
|---|---|---|---|---|---|---|---|---|
| Translucent silver film | Excellent | Very good | Good | Good | Very good | Very good | Very good | Very good |
| Silver film | Excellent | Very good | Good | Good | Very good | Very good | Very good | Very good |
| Aluminum film | Excellent | Verygood | Good | Good | Very good | Very good | Very good | Very good |
| Translucent silicon film | Excellent | Very good | Good | Good | Good | Good | Good | Good |

Combination of translucent silver film and silver film

| | | | | | | | | |
|---|---|---|---|---|---|---|---|---|
| Moisture-heat resistance | Excellent | Excellent | Very good | very good | Very good | Excellent | Very Good | Good |
| Edge curability | Excellent | Excellent | Excellent | Excellent | Very good | Good | Good | Excellent |

Combination of translucent silver film and aluminum film

| | | | | | | | | |
|---|---|---|---|---|---|---|---|---|
| Moisture-heat resistance | Excellent | very good | Very good | Very good | Very good | Very good | Very good | Good |
| Edge curability | Excellent | Excellent | Excellent | Excellent | Very good | Good | Good | Excellent |

Combination of translucent silicon film and aluminum film

| | | | | | | | | |
|---|---|---|---|---|---|---|---|---|
| Moisture-heat resistance | Very good | Very good | Good | Good | Good | Very good | Good | Good |
| Edge curability | Excellent | Excellent | Excellent | Excellent | Very good | Good | Good | Excellent |

TABLE 2

| | | | | | | | Com- | Com- | Com- |
|---|---|---|---|---|---|---|---|---|---|
| | | | Example | Example | Example | Example | parative | parative | parative |
| | | Example 9 | 10 | 11 | 12 | 13 | Example 1 | Example 2 | Example 3 |
| A | VR77 (bisphenol A diglycidyl ether acrylate | 35 | 35 | 35 | 35 | 35 | 10 | 40 | 35 |
| | adduct) | | | | | | | | |
| B | Tricyclodecane dimethanol diacrylate | 40 | 40 | 40 | 40 | 40 | 60 | 20 | 25 |
| | Ethylene oxide addition bisphenol A | | | | | | | | |
| | Diacrylate | | | | | | | | |
| | Tetrafurfuryl Acrylate | | | | | | 4.2 | 4.7 | 10 |
| | Tetraethylene glycol diacrylate | 7.7 | 7.7 | 7.7 | 7.7 | 7.7 | 4 | 4 | |
| | Tripropylene glycol diacrylate | 5 | 5 | 5 | 5 | 5 | | 10 | 8.7 |
| | N-Vinyl caprolactam | 5 | 5 | 5 | 5 | 5 | | | |
| | Oligomer (UA) | | | | | | 15 | 15 | 15 |
| C | 2,2-Dimethoxy-1,2-diphenylethan-1-one | 3 | 3 | 3 | 3 | 3 | 3 | 3 | 3 |
| | 2-Hydroxy-2-methyl-1-phenylpropan-1-one | | 1.5 | 1.5 | | | 3 | 3 | 3 |
| | 1-Hydroxycyclohexyl phenyl ketone | 3 | | | | | | | |
| | 2,4,6-Trimethylbenzoyl diphenylphosphine oxide | | 1.5 | | 3 | | | | |
| | Bis(2,4,6-trimethylbenzoyl)phenylphosphine | | | 1.5 | | 3 | | | |
| | oxide | | | | | | | | |
| D | Ethyl dimethylaminobenzoate | 0.5 | 0.5 | 0.5 | 0.5 | 0.5 | 0.5 | | |
| E | 2-Mercaptobenzothiazole | 0.5 | 0.5 | 0.5 | 0.5 | 0.5 | | | |
| | Irganox 1035 | 0.3 | 0.3 | 0.3 | 0.3 | 0.3 | 0.3 | 0.3 | 0.3 |

Adhesiveness

| | | | | | | | | |
|---|---|---|---|---|---|---|---|---|
| Translucent silver film | Very good | Very good | Very good | Very good | Very good | Bad | Very good | Good |
| Silver film | Very good | Very good | Very good | Very good | Very good | Bad | Very good | Good |
| Aluminum film | Very good | Very good | Very good | Very good | Very good | Bad | Very good | Very good |
| Translucent silicon film | Very good | Very good | Very good | Very good | Very good | Bad | Very good | Good |

Combination of translucent silver film and silver film

| | | | | | | | | |
|---|---|---|---|---|---|---|---|---|
| Moisture-heat resistance | Excellent | Excellent | Excellent | Very good | Very good | Very good | Bad | Bad |
| Edge curability | Excellent | Excellent | Excellent | Excellent | Excellent | Very good | Bad | Bad |

Combination of translucent silver film and aluminum film

| | | | | | | | | |
|---|---|---|---|---|---|---|---|---|
| Moisture-heat resistance | Very good | Very good | Very good | Very good | Very good | Good | Bad | Bad |
| Edge curability | Excellent | Excellent | Excellent | Excellent | Excellent | Very good | Bad | Bad |

Combination of translucent silicon film and aluminum film

| | | | | | | | | |
|---|---|---|---|---|---|---|---|---|
| Moisture-heat resistance | Very good | Very good | Very good | Very good | Very good | Good | Bad | Bad |
| Edge curability | Excellent | Excellent | Excellent | Excellent | Excellent | Very good | Bad | Bad |

1. A radiation-curable resin composition for adhesives comprising (A) a bisphenol-type epoxy (meth) acrylate having a hydroxyl group, (B) a polyfunctional (meth) acrylate having an aliphatic cyclic structure or an aromatic cyclic structure other than the component (A), and (C) a photoinitiator, wherein the content of the component (A) and the content of the component (B) in the composition are respectively 30 wt % or more.

2. The radiation-curable resin composition for adhesives according to claim 1, wherein the component (A) comprises a bisphenol A skeleton, has a number average molecular weight of 400-3000, and is contained in the composition in an amount of 35 wt % or more.

3. The radiation-curable resin composition for adhesives according to claim 1, wherein the component (C) comprises two or more different compounds.

4. The radiation-curable resin composition for adhesives according to claim 1, further comprising (D) a dialkylamino benzoate.

5. The radiation-curable resin composition for adhesives according to claim 1, further comprising (E) an aromatic thiol compound.

6. The radiation-curable resin composition for adhesives according to claim 5, wherein the content of the component (E) in the composition is 0.01-5 wt %.

7. An adhesive for optical disks comprising the radiation-curable resin composition according to claim 1.

8. An optical disk comprising the radiation curable resin composition according to claim 1.

9. An optical disk comprising the adhesive according to claim 7.

10. An optical disk comprising a translucent film made of silver or a compound or an alloy comprising silver as the main component, a reflection film made of aluminum or a compound or alloy containing aluminum as the main component and a suitably cured adhesive according to claim 7.

11. An optical disk comprising a translucent film made of silicon or a compound or alloy comprising silicon as the main component, a reflection film made of aluminum or a compound or alloy containing aluminum as the main component and a suitably cured adhesive according to claim 7.

12. The radiation-curable resin composition for adhesives according to claim 2, wherein the component (C) comprises two or more different compounds.
